(19) United States
(12) Patent Application Publication
(10) Pub. No.: US 2013/0151423 A1
(43) Pub. Date: Jun. 13, 2013

(54) VALUATION OF DATA

(71) Applicants: Robert Schmidt, St. Louis, MO (US); Jennifer T. Fisher, St. Louis, MO (US)

(72) Inventors: Robert Schmidt, St. Louis, MO (US); Jennifer T. Fisher, St. Louis, MO (US)

(73) Assignee: WELLS FARGO BANK, N.A., Charlotte, NC (US)

(21) Appl. No.: 13/316,055

(22) Filed: Dec. 9, 2011

(51) Int. Cl. G06Q 40/00

(52) U.S. Cl. 705/306

(57) ABSTRACT

Systems and methods that provide for valuing data are discussed herein. These systems and methods can provide for determining an initial measure of value of the data asset and calculating a baseline monetary ratio based at least in part on the initial measure of value. Additionally, the innovation can include measuring one or more quality factors associated with the data asset, measuring a utility associated with the data asset, calculating a new measure of value of the data asset based at least in part on the baseline monetary ratio, the utility, and the one or more quality factors, and reporting the new measure of value.

### BACKGROUND

Data has value, but conventional systems and methods do not value it in the accounting sense. Conventional systems and methods can value many abstract things up to and including goodwill, but do not include a way to value data.

Clearly, data has value. For example, the actual value of a company without its data would be noticeably less than with its data. However, removing a company's data entirely would not change that company's balance sheet, because in conventional systems and methods the data is valued at zero. In actuality, a company minus all the data might be worth only pennies on the dollar. Without the data, value could be lost in a number of ways: there would be no evidence of value, the company might not be able to continue operations, and the cost of reassembling the data could be prohibitive. In some situations, many modern companies (e.g., Internet search companies or social networking companies) have revenue based entirely on data rather than on physical assets. Thus, in a real economic sense, the data can comprise a large part of a company's value.

Assets that have no value are called “free goods” by economists. Air is a free good, water is a free good. By not assigning any value to data, conventional systems effectively regard it as a free good despite its value.

In conventional accounting systems, if a company were to spend an additional 2% of its budget to improve the quality of its data, that decision would only be reflected on the books as if the company spent 2% more money. The improved quality of the data would not be measured or accounted for.

Likewise, if a company were to spend an additional 2% to teach users to use the data in its system and help its community get more use of it, to management it would only look like increased support costs, decreased performance, and an increase of 2% in spending.

Thus, although high quality data that is used by more people would seem to be a good thing, any effort to improve the quality and the utility of data is measured in conventional systems as cost with no offsetting gain. The expense is measured, but the increase in the value of the data asset is not. This “data is free” mentality stymies investment in quality data.

Because conventional accounting systems and methods do not give data a monetary value, executives and others cannot evaluate efforts to collect, maintain, and improve data in a way that is approachable and easily understandable. Without a measure of the value of data, executives and others lack the necessary information to make the most effective decisions about where investments should be made, for example, whether to invest more on data and less on fuel, etc.

### SUMMARY

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The innovation disclosed and claimed herein, in one aspect thereof, comprises a system that facilitates valuation of data. The system can include a data value management component that can determine a measure of value of the data asset. The measure of value can be determined based at least in part on a baseline monetary ratio and a non-monetary measure of quality based on one or more factors. Additionally, the system can include a communication component that can output the measure of value.

In another aspect of the subject innovation, some embodiments can include one or more methods of valuing data. Such a method can include the act of determining an initial measure of value of the data asset. Also, the method can include the act of calculating a baseline monetary ratio, which can be based at least in part on the initial measure of value. Additionally, the method can include the steps of measuring one or more quality factors associated with the data asset and calculating a new measure of value of the data asset based at least in part on the baseline monetary ratio and the one or more quality factors. In aspects, the method can include the act of reporting the new measure of value.

In yet another aspect thereof, an artificial intelligence component is provided that employs a probabilistic and/or statistical-based analysis to prognose or infer an action that a user desires to be automatically performed.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIG. 1 illustrates a system capable of valuing data in accordance with aspects of the subject innovation.

FIG. 2 illustrates an example data value management component in accordance with aspects of the subject innovation.

FIG. 3 illustrate a method of valuing data in accordance with aspects of the subject innovation.

FIG. 4 illustrates a block diagram of a computer operable to execute the disclosed architecture.

FIG. 5 illustrates a schematic block diagram of an exemplary computing environment in accordance with the subject innovation.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

As used in this application, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

As used herein, the term to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

While certain ways of displaying information to users are shown and described with respect to certain figures as screenshots, those skilled in the relevant art will recognize that various other alternatives can be employed. The terms “screen,” “web page,” and “page” are generally used interchangeably herein. The pages or screens are stored and/or transmitted as display descriptions, as graphical user interfaces, or by other methods of depicting information on a screen (whether personal computer, PDA, mobile telephone, or other suitable device, for example) where the layout and information or content to be displayed on the page is stored in memory, database, or another storage facility.

In various embodiments, the subject innovation relates to systems and methods capable of placing a value (e.g., monetary value, etc.) on data. A number of factors can affect the relative value of data. The subject innovation relates to techniques that can determine and place a value on data based on one or more measures related to one or more of these factors. For example, data that is more accurate is more valuable than data that is less accurate. There are other value propositions that can apply in many situations, such as “current data is more valuable than old data” and “more useful data is more valuable than less useful data.” In some situations, the proposition, “Data that is used often is more valuable than data that is rarely used” can be used to summarize and substitute for the quantity and age of the data. Also, proprietary data can be more valuable than data that is in the public domain. In aspects, techniques of the subject innovation can include one or more valuations of data based at least in part on at least one of these relative statements of value. These techniques can be used to determine whether data is becoming more or less valuable over time independent of expenditures.

Data that costs more to collect and maintain is not necessarily more valuable. However, it can be useful to measure data in terms of value (e.g., monetary value, etc.) for a variety of reasons, for example, so that executives and others can compare data investments with other investments. In aspects, ways of measuring data value in accordance with the subject innovation can be based at least in part upon establishing a local currency baseline. In one example, the total investment in information technology (IT) can be one such baseline for establishing the value of data, since investment in information technology (IT) can be regarded as ultimately an investment in data.

In various embodiments, the subject innovation can include systems and methods that can apply a relative value of data based on measurable quantities to a monetary value baseline. As described herein, a variety of measures can be used to determine a value of data.

As used herein, “data” is intended to be broadly inclusive of information in a variety of forms, including (but not limited to) digitally stored information and records. As non-limiting examples, a database can be considered data, as can all the rows and every cell in various tables, as can unstructured data. Examples can include various information companies may or may not consider valuable, such as whether a customer paid $100 or $110. The subject innovation relates to ways to determine whether this information in these and other records have value, as well as quantifying that value.

An asset is something that can create value over time. Generally, data that can be used can provide some value. If a use of data proves futile, then people will stop using that data that way. If a use of data proves fruitful, however (e.g., it can help people to buy low and/or sell high, etc.), then people will use that data repeatedly. Although data can be misused, this does not affect whether or not it has value or is an asset, and on average, valuable uses of data will prevail. For example, other assets, such as money, are often misused (e.g., poorly spent or worse, etc.), yet money is still considered an asset. If data is being used, then it is likely delivering value.

Data can create value in a variety of ways. One way data can create value can be by simply reaching a “statistically relevant” threshold or by alloying with other data. Examples can include the market value of knowing: the frequency at which the public performs Internet searches for phrases such as “Honda,” the number of Silly Bands sold over the last six weeks, crop tests over five years, combining USDA soil data with NOAA weather data, etc. Thus, at least in some situations, data can become more valuable in the aggregate.

Techniques of the subject innovation relate to creating one or more credible measures of the value of data. Credible measures motivate people in powerful ways in a wide variety of fields: report cards, speed limits, cholesterol levels, etc.

If data were to be valued in a well reasoned way, organizations might be held accountable for the quality of their data. For example, organizations might be expected to only have a warehouse if there is a demand for the product that is warehoused. Likewise, an organization might be expected to provide security for data if its value depends on not letting just anybody see it.

If at a point in time it can be determined that some data is accurate, used, current, abundant, and secure; and, at some other point in time that efforts had made that data more so, then a return on investment (ROI) could be shown. In aspects, techniques of the subject innovation provide one or more measures that allow for such determinations of the value of data. Providing such measures can raise awareness of and interest in improving data quality, and informed investing in information technology and data.

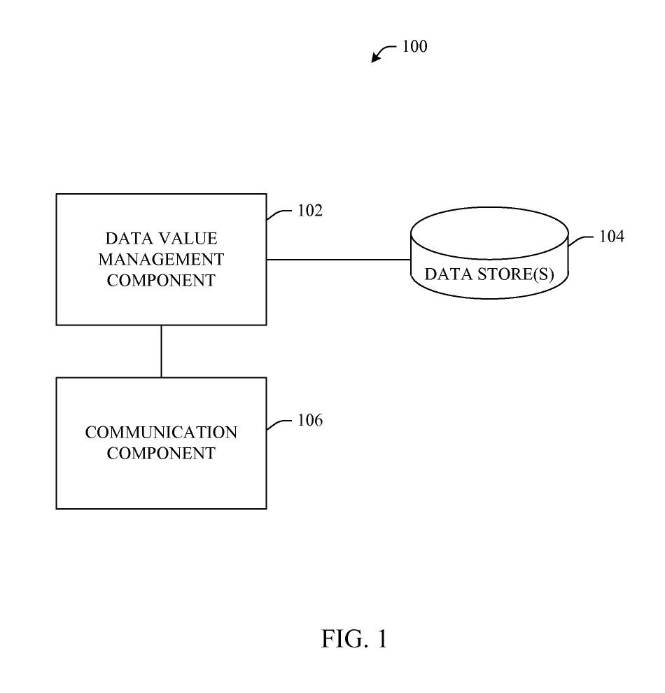

Turning to FIG. 1, shown is a system 100 capable of valuing data in accordance with aspects of the subject innovation. System 100 can include a data value management component 102 that can provide for determining one or more measures of value of at least one data asset maintained in one or more data stores 104. The at least one data asset can include any of a variety of data assets or products (which are variously referred to herein by one or more of the terms “database(s),” “set(s) of data,” “data asset(s),” “data product(s),” “information technology (IT) asset(s),” “IT product(s),” and other similar terms, each of which is intended to be broadly inclusive of one another, unless the circumstances specifically indicate that a narrow meaning is intended). The following are examples of data assets: one or more databases (or subsets thereof or individual elements therein, etc.) used or maintained by a company, considered separately or collectively; some or all of the products produced, used, or maintained by an IT department; and other examples. In various embodiments, the data value management component 102 can make one or more determinations related to at least one quality or factor of a data asset (e.g., the accuracy, the extent to which it is used, the extent to which it is proprietary, the size of the data asset, how recent or current the data in the data asset is, etc.). In some embodiments, communications component 106 can provide information to the data value management component 102 upon which these one or more determinations can be based, for example information related to an audit performed on at least a portion of a data asset (e.g., if an external or internal audit is performed separately from system 100, results can be provided through communication component 106, etc.). Based on the at least one quality or factor, data value management component 102 can determine at least one measure of value for the at least one data asset. In aspects, data value management component 102 an initial measure of value can be determined for the at least one data asset, and data value management component 102 can update the initial measure of value at one or more later points in time (e.g., periodically such as quarterly, yearly, etc., or intermittently, etc.). The initial measure of value can be based at least in part on the one or more qualities, and can also be based on additional information received from one or more of data store(s) 104 or communication component 106, such as expenditures on IT or data assets over a given period of time (e.g., a number of years, such as 7, etc.), etc.

In some aspects, data value management component 102 can determine an initial value of a data asset to be equal to IT expenditures over the given period of time, based on a cost of gathering information associated with the data asset, or can reflect both. The data value management component 102 can also determine a non-monetary measure of quality (such as that referred to herein as “data base atoms of use” or DBAU) of the data asset, based on one or more factors (e.g., the accuracy, the extent to which it is used, the extent to which it is proprietary, the size of the data asset, how recent or current the data in the data asset is, etc.). In one aspect, the non-monetary measure of quality can be determined by the data value management component 102 to be equal to a function of an accuracy A of the data asset (e.g., A³, etc.) multiplied by a total measure of the access or use U associated with the asset over a period of time (e.g., as a sum of all uses, such as “clicks,” or accesses to the information, summed over the entire data asset and entire period of time). The data value management component 102 can calculate the ratio of the initial value of the data asset to (i.e., divided by) the non-monetary measure of quality as a baseline monetary ratio (e.g., similar to d as a ratio of dollars (or other monetary units) per unit of quality or utility, as described further herein). At a later point in time, the non-monetary measure of quality can be re-determined by the data value management component 102, which can multiply this baseline monetary ratio to obtain a new measure of value. In aspects, data value management component 102 can transmit results based at least in part on the measure of value to communication component 106, which can provide or output the results to one or more entities (e.g., presenting results to executives, storing results in a database, including in data store 104, etc.). These results can include a most recent measure of value, one or more historical measures of value (potentially including the initial measure of value), as well as information based on one or more measures of value (e.g., trend information, comparisons among different departments or companies, etc.).

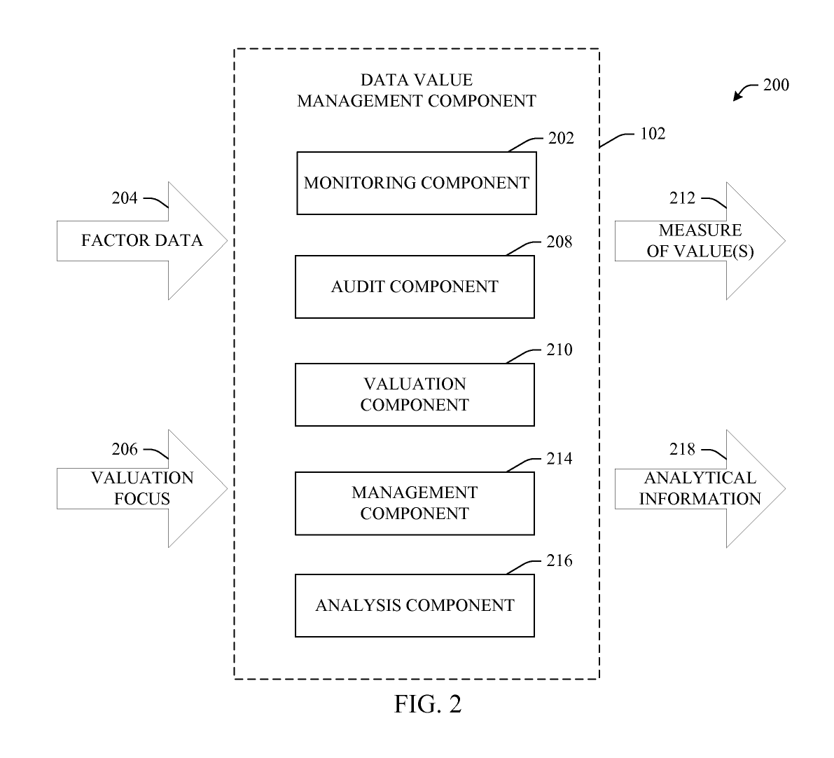

Turning to FIG. 2, illustrated is an example data value management component 102 in accordance with aspects of the subject innovation. In various aspects of the subject innovation, data value management component 102 can comprise one or more other components. In some embodiments, data value management component 102 can include a monitoring component 202 that can monitor a data asset such as in a data store 104. This monitoring can include determining information related to one or more factors upon which a measure of value can be based (e.g., the accuracy, the extent to which it is used, the extent to which it is proprietary, the size of the data asset, how recent or current the data in the data asset is, etc.). In some aspects, this can include factor data 204 received from outside of the data value management component 102, such as information maintained in a data store 104, provided by an external entity, etc. In aspects, the monitoring can include tracking one or more factors on an ongoing or periodic basis, such as a number of uses or accesses of the data asset over a period of time, a size of the data asset, when and to what extent the data asset is updated, etc. In such a manner, monitoring component 202 can assemble information related to one or more factors on which a value of the data asset can be based. Factor data 204 can include additional information that can be received externally to system 100, for example, the results of an audit of the data asset that determined information related to one or more factors (e.g., an accuracy of at least a subset of the data asset, etc.).

Additionally, in some embodiments, data value management component 102 can receive information related to a valuation focus 206, such as which factors should be included in a measure of value of the data asset, and in some aspects, how much emphasis should be placed on those factors or how they should appear in a formula measuring value. In many embodiments, this can be received once, initially, or need not be received, in which case a valuation focus can be implicit, in that a default or general measure of value can be used (e.g., using one or more formulas discussed herein, etc.). In other embodiments, a valuation focus 206 can be updated or changed. For example, a company may be in an industry wherein data quickly becomes outdated. In such a case, they may wish to emphasize or increase emphasis on the extent to which data is current (e.g., a measure of value may be desired such that the value of the data asset is discounted or reduced proportionally to the extent it is not current, such as a certain amount per day, week, month, etc.). In the event the valuation focus 206 is updated, a current or most recent measure of value can be used as a new “initial” measure of value, and a DBAU can be determined based on the new valuation focus 206, after which the system 100 can continue, substitute the new DBAU for the old, such that the value can change from its current value based on the new DBAU, yet can also be based on the current value.

In aspects, data value management component 102 can include an audit component 208 that can perform one or more tasks associated with an audit of at least a subset of a data asset. In one example, audit component 208 can determine the subset of the data asset to be audited. This subset can be selected in a variety of ways. In some aspects, some or all of the subset can comprise data that has been designated as priority or important data, such as data that has designated as relatively high value data (e.g., designated externally to the system, or determined by a system or method described herein, etc.). Additionally or alternatively, some or all of the subset can be selected at least one of randomly, or based on elements that have not been selected recently (e.g., have not been selected within a certain period of time, or are among the elements that have never been selected, or among those that have been least recently selected, etc.).

In other aspects, audit component 208 can be used to at least partially audit the data asset, for example in situations wherein information is available for use in auditing the data, such as records against which at least a portion of the data asset can be compared. In some aspects, audit component 208 can compare at least a portion of the data asset to one or more records to determine at least one of an accuracy of the portion or whether information that was confidential is known to no longer be so, etc. In other aspects, audit component 208 can prepare or identify one or more records that can be used for auditing at least a portion of the data asset, which can assist in an audit of the data asset (although other records may need to be identified, gathered, etc.). In some aspect, this audit can occur at or near the end of a period of time for which a valuation is to be determined, or in other aspects, can occur on an ongoing basis, with results assembled at or near the end of the period.

In one or more embodiments, data value management component 102 can include a valuation component 210. Based on either a valuation focus 206 or a default choice for how to determine a measure of value 212, valuation component 210 can compute a measure of value 212 of the at least one data asset. In one example, this measure of value can be based at least in part on a baseline monetary ratio, a determined accuracy (e.g., based on a subset of the data asset, for example as determined in an audit of the data asset, etc.), and how much the data asset has been used (e.g., as measured by instance of access, use, or “clicks,” etc.). In one example, the measure of value 212 (V) can be equal to the baseline monetary ratio (d) multiplied by an accuracy (A) cubed, multiplied by a sum of how much the data asset has been used (Σ₁ⁿΣ₁^{t}U) over a given evaluation period (V=d*A³Σ₁ⁿΣ₁^{t}U). In various embodiments, more than one measure of value can be calculated, based on more than one formula for measuring value, more than one data asset, or both. The one or more measures of value 212 can be presented in a variety of forms, for example as a monetary value, potentially with additional information (e.g., one or more historical values; an indication of whether the value increased or decreased since a last evaluation period; evaluation of the value over time, such as in a graph, chart, etc.).

In some embodiments, a management component 214 can be included in data value management component 102. Management component can coordinate the actions of one or more components of system 100 or data value management component 102. For example, management component 214 can determine a schedule for the evaluation periods for which a measure of value 212 is to be determined. In another example, management component 214 can schedule actions of one or more components of system 100 relative to the evaluation period, such as when various actions by components of system 100 (or sub-components of data value management component 102) are to take place.

In aspects, data value management component 102 can include an analysis component 216 that can perform further analysis to related to the one or more measures of value 212, which can be based at least in part on the factor data 204. In aspects, this can involve determining one or more of trends or correlations associated with at least one of a measure of value 212 or the factor data 204. In some aspects, one or more relational database queries can be done to determine correlations or trends among the one or more factors (e.g., accuracy, uses, etc.). For example, if accuracy is lower than otherwise desired, it can be determined whether or not this is a general trend (e.g., such that global action may be most beneficial, etc.), or whether it correlates with something specific (e.g., a specific data set, a specific store, etc., such that specific action can be more effective.). In another example, if value decreases because uses are lower than desired, but this is found to be because they were lower for a time that correlated with a new IT product being deployed but then trended back to previous or greater levels, a change in action might not be necessary despite the lower value. Information based on the further analysis can be provided as analytical information 218, which can, in aspects, be provided with the one or more measures of value 212.

While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

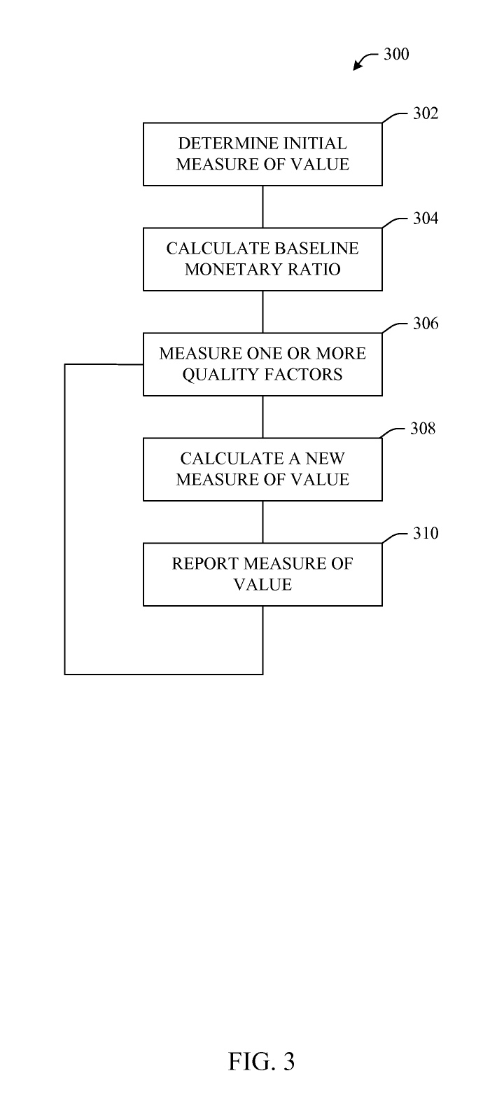

Turning to FIG. 3, illustrated is a method 300 of valuing data in accordance with aspects of the subject innovation. The method can begin at step 302, where an initial measure of value of one or more data assets can be determined, for example, to be equal to expenditures on the one or more data assets over a fixed period of time (e.g., as determined by total IT expenditures, IT expenditures attributable to the one or more data assets, etc.). Optionally, the method can also include receiving a selected measure of determining value, such as from among those measures discussed herein, etc. Whether such a measure is received or a default measure is employed, a non-monetary measure of quality can be determined in accordance with the measure of value, and at step 304, a baseline monetary ratio between the measure of value and the non-monetary measure of quality can be calculated. At step 306, at the end of an evaluation period (e.g., of predetermined length, etc.), one or more quality factors of the one or more data assets can be measured. This measuring can take place during or near the end of the evaluation period, and measuring can comprise aggregating measured results. In aspects, this can also include receiving results related to an audit of at least a subset of the one or more data assets (e.g., an audit of a portion of the data assets to estimate an accuracy of the portion, etc.). Next, at step 308, a new measure of value can be calculated. In aspects, the measure can be calculated by determining a non-monetary measure of quality (e.g., a DBAU, etc.) and multiplying that by the baseline monetary ratio. At step 310, the new measure of value can be reported out, such as in monetary units, and optionally with additional information, such as one or more historical measures of value, a graphical representation associated with one or more measures of value, analytical information (e.g., trends, correlations, etc.). After an evaluation period, the method can return to step 306 to measure one or more quality factors of the one or more data assets. Optionally, based at least in part on the one or more measures of value, an organization can make one or more financial or organizational (e.g., business, etc.) decisions, such as whether and how much money to allocate to IT, whether to place increased emphasis on training or product awareness, whether to place greater emphasis on improving accuracy of records, etc.

One or more measures of value in accordance with the subject innovation are discussed in greater detail below. In aspects of the subject innovation, any or all of several potential criteria can be used herein to establish a measure of the value of data. These criteria can include: (1) accuracy of the data; (2) how recent or current the data is; (3) the quantity of data; (4) The rate or extent to which data is used; (5) whether the data is proprietary or confidential, etc. Valuations of data discussed herein can be based at least in part on one or more of these factors, or on others. However, measures of worth such as the valuations discussed herein are distinct from physical measurements such as meters or liters—there is no way to arrive at that kind of precision or even clarity about what is measured. Although a settled value can be produced for anything, measures of value are not fundamental truths, but are agreed upon at a point in time. For example, the “Blue Book” value of a car is not an accurate measure, but it is useful nonetheless. Although measures of value may lack precision, usefulness can be more important than precision.

The measures of data values discussed herein can be one or more of directional or comparable, for example, in that values (e.g., before and after certain actions, etc.) can be compared or directions of changes (e.g., whether value increased or decreased) can be determined. These characteristics can help executives and others (e.g., a CIO, etc.) make better-informed decisions. Aspects of the subject innovation can provide for determining relative values of data. For example, embodiments of the subject innovation can provide one or more reasonable and consistent measures by which it can be determined, for example, whether quality of data went up based on investment in data clean up. In another example, with such a measure, an analyst could estimate the cost of lax data validation or too little testing.

Although specific techniques for valuing data are discussed herein, it is to be appreciated that other techniques, for example, based on principles discussed herein (e.g., accuracy of data, the extent to which data is used, etc.), are intended to be within the scope of the innovation. The exact nature of data quality or what constitutes the use of data can be evaluated in multiple ways that may have differing advantages or disadvantages, but each of these aspects of the subject innovation differ markedly from conventional systems that entirely fail to value data. The existence of multiple methods of valuation is not unique to data. For example, accountants argue about the value of simple assets such as machines and even money. However, that does not keep them from valuing many things less tangible than data: options, goodwill, future tax credits, etc. Disagreements about ways of valuation will go on forever, but the subject innovation provides multiple embodiments that can provide one or more valuations of data that can be useful for settling on a course of action.

In aspects, the subject innovation provides one or more useful measures that encourage better behavior, for example, better decision-making regarding expenditures. Because aspects of the subject innovation can drive good behavior, the one or more measurements discussed herein can provide for numerous applications. As an illustrative example: if a company plans to improve data quality and hires 1,000 temps for a month to clean up the data, the cost relative to the change in accuracy can be measured according to one or more techniques discussed herein. As an alternative, the company could hire a really talented analyst using an expensive rules engine to get a similar measure. Using techniques discussed herein, these two alternatives can be compared to determine which provides the better ROI.

Although specific measures of valuation of data are discussed below, it is to be appreciated that variations on these measures are also within the scope of the innovation. In various aspects, one or more measures that can be used for valuing data can be made consistently and independently of other IT processes, and can be used to make better-informed decisions that can drive better behavior (e.g., decision-making regarding potential expenditures involving data, etc.).

In various aspects, techniques of the subject innovation can include measures of value of data based at least in part on an accuracy of the data. Accurate data can be more valuable than inaccurate data. In accordance with the subject innovation, accuracy can be determined in one or more ways. For example, a subset of the data can be randomly sampled and audited to determine an accuracy of the subset. This auditing can occur internally or externally: in one example, an audit firm or other external entity performing an audit can randomly select a number of transactions and then verify their accuracy, either manually or in a partially or wholly automated manner. Auditing can, in aspects, include communication with other parties involved in transactions, for example, by cross-checking with their records. The accuracy (e.g., of the data, of the subet, etc.) can be represented in any of a variety of ways, for example, as a percentage (e.g., if 100 records are checked, and 99 are determined to be accurate, this accuracy can be represented as 99%, etc.).

In aspects, accuracy can be determined based on one or more precision criteria. One example of an accuracy factor can be represented as the fraction or percentage of audited data points meeting the one or more precision criteria out of all audited data points: # of data points meeting precision criteria/all audited data points=A.

In some embodiments that are based on more than one precision criteria, a data point can be regarded as accurate only if all criteria are met, while in others, a partial or fractional accuracy can be assigned (e.g., if one transaction was found to be accurate with respect to 3 of 4 criteria, it could be assigned an accuracy of 75% so as to value as 0.75 of a data point meeting precision criteria for purposes of determining accuracy of the set of data, etc.). In various embodiments, the one or more precision criteria can include at least one range, such that data that is accurate to within that at least one range. In some aspects, a measure of accuracy of data can include additional information. For example, if a single erroneous transaction was supposed to be $1.01 but was recorded as $1.00, the accuracy could be stated as: “100% of all transactions were within 2% of the expected value.” Because a measure of value can encourage behavior to increase that value, measuring value in part based on accuracy can encourage behavior that can improve the accuracy of data.

In some embodiments, a quantity of data can be a factor upon which a measure of the value of data can be based, at least in part. In many situations, having more data is better than having less data. Also, in various embodiments, the value of data can be based at least in part on the extent to which the data is current. There are multiple situations where having recently gathered data (current data) is more valuable than old data, but unlike accuracy, it is not always more valuable. In embodiments comprising measures of value of data that are useable as generally applicable measures, these factors need not be included. In general, a greater quantity of data is not necessarily more valuable than a smaller quantity: a system can spin off terabytes of worthless data. Data that is not used is not an asset and having lots of data that is not used is no more valuable. Likewise, there are many exceptions to the general rule that current data is more valuable. Data that is days old can be worthless depending on the application, while ancient data can be highly valuable in many situations, such as long trends in a natural system. Because a greater volume of data or more recent data are not necessarily more valuable than less data (which may, for example, be easier to use and thus more used, etc.) or older data, not all measures of value discussed herein include these factors.

However, in some embodiments (e.g., to be used in specific fields or with specific kinds of data, etc.), either or both of these factors can be included. Measurement of the size or quantity of data can be relatively simple for a dataset, and when this factor is included, a value can be based on some function of the size of the data. In some situations, more data may be more valuable, and it can be reflected as such in a measure of value, while in other situations, more data may be less valuable beyond a certain point, and a measure of value can include an expression related to the quantity of data reflecting that relationship.

In various aspects, techniques of the subject innovation can include measures of value of data based at least in part on the extent to which data is used. In general, the more something is or will be used (e.g., data, etc.), the more valuable it is. People and organizations value things they use or intend to use; the things they do not use are regarded as less valuable.

In the context of the value of data, an information systems department that does not have people use its product or products has little or no value, no matter how much investment is made into that department. With no other changes, the value of such a department could increase dramatically simply by getting people to use those products. There are people in every organization who would benefit from features, reports and systems that they do not know exist or know how to use effectively. As an IT manager increases the distribution of data, they are increasing its value. When a company sells a large amount of a product, they need to obtain more to continue sales. Executives at companies of all sizes and in all fields could not imagine running their companies not knowing what products their customers used, but most IT departments do not know if the data they create is used.

Knowing what data is in demand can help IT departments make better-informed decisions, such as where to allocate resources. For example, highly utilized data can get extra attention, such as for performance improvements, for audit, etc. In another example, data that is underutilized may indicate poor data quality, poor performance, or low acceptance of an application. As with other factors upon which a measure of value can be based, a measure of value based on the extent to which data is used can drive behavior to increase the use of data. Measuring the value of data based on utilization will cause organizations to get more out of their investments in data in that they will make decisions that will increase the use of that data.

Measurement of the use of data can occur in a variety of ways. For example, ‘hits’ or a number of times that a data set is used can be determined, or can be monitored over a period of time. By dividing by a period of time, a rate of use over time can be determined. In another example, in settings where access of data can be associated with one or more discrete projects, usage of data can be associated with those projects, and greater weight can be assigned to data used in connection with more valuable projects (e.g., the value can be proportional to the sum of the products of the uses on each project with the value of the projects, or the value of the project divided by a number of data sets used in connection with the project, etc.).

In some embodiments, measures of the value of data can be based at least in part on whether and to what extent data is proprietary. Information that is not publicly known can be more valuable than information which is, and this can be reflected in a measure of value in various embodiments. In some circumstances, the maintenance of proprietary information can create an increased risk (e.g., maintaining credit card information can allow customers to make additional purchases more quickly, but can be costly in terms of lost customers in the event a company is hacked, etc.). However, estimating the risk of holding confidential data need not be included in the valuation of the data, for example, because it can be specific toward an industry or type of data. Measuring value based on the extent to which data is confidential could be accomplished in a variety of ways (e.g., by determining a fraction or percentage of the data that is confidential, such as 30%, and increasing the value proportionally to the fraction that is confidential, etc.).

In aspects, some data elements may be recognized as more valuable than others in a set. The significance of these elements can be incorporated into value considerations in multiple ways, for example, by ensuring that those data elements will be among the ones selected for audit, measurement of use, etc. This can be similar to the approach used in the development of the Dow Jones Index, which is based on a mere thirty stocks. Although relevance need not explicitly represented in the data valuation formula, in aspects, recognition of importance can be made inherent in the process of narrowing down the list of data elements to be audited. In other aspects, some or all of the data elements selected for auditing or other analysis can be selected randomly (e.g., among all elements, among elements that have not been audited or otherwise analyzed, among elements that have the greatest time since being audited or otherwise analyzed, etc.).

In certain embodiments, assigning a monetary value to data can be based at least in part on the extent to which data is used and the accuracy of the data. Additionally, in aspects, relevance or importance to the organization of a subset of the data can be incorporated into the measure in one or more ways, such as by selection of which of the data elements to measure, etc. In the one or more example formulas discussed herein, the number of elements selected is represented by n.

The measure of the usefulness or utility of the database is represented by the variable U in the formulas discussed herein. Utility can be measured on a data element and instance level. As an example, the following select statement returns 100 rows once and 110 rows when run again later: Select a, b from t. U=(2*100)+(2*110)=420, where the 2 appears in the formula as a result of there being two data elements (a and b) selected. Utility can be measured over a proscribed time (e.g., a week, a month, etc.); the time can be represented by t in formulas discussed herein.

In formulas discussed herein, accuracy can be represented by the variable A. Accuracy can be included as a factor that can discount the value as determined by the usefulness of the data to the extent that the data is inaccurate (e.g., linearly or nonlinearly, etc.). Including accuracy in the formula can build into the metric an incentive to improve accuracy. Accuracy can be measured on a data element by data element basis and can be measured at some point in the relevant period. In some aspects, accuracy can be represented as a percentage. For instance, if one data point in 100 was found to be in error, then the accuracy would be 99%. In various embodiments, the accuracy of a data set can be based on a sampling or survey of that set of data, for example, estimating the accuracy of the whole based on the accuracy determined for elements selected in the sampling or survey.

An interim product such as a non-monetary measure of quality based on accuracy and a measure of usefulness, utility, or use can be regarded as a number of atoms of value derived from a database, which is referred to herein as “data base atoms of use” or DBAU, and, in one example, can be equal to: (A³*Σ₁ⁿΣ₁^{t}(U)), which in an embodiment wherein U is measured by a number of times the data was accessed, used, or “clicked”, DBAU would be equal (in this example) to A³ times the number of uses or accesses, summed over the entire data set of interest, over the period of time it is being monitored (e.g., one measurement cycle, etc.). However, in other aspects, DBAU can have a different dependence on at least one of A or U. For example, the A³ term could instead be another power of A (e.g., a positive real number, etc.), or some other monotonically increasing function of A. Likewise, the U term need not be linear, but could be some other monotonically increasing function of U. Additionally, in other embodiments, terms can be included to represent one or more of the size of a set of data (e.g., as a multiplicative term to increase the DBAU as it increases, as it decreases, or in a non-monotonic manner, etc.), how recent data is (e.g., as a multiplicative term to increase the DBAU as it becomes more recent, as it becomes older, or in a non-monotonic manner, etc.), whether and to what extent data is proprietary (e.g., as a multiplicative term to increase the DBAU based on a greater portion of the data being proprietary, etc.).

Measures of value discussed herein can be based at least in part on monetizing the above formula for DBAU or variations on that formula. The formula or formulas can be monetized by introducing a term for dollars per unit of utility or quality in the formula, which is represented by d. In some aspects, d can be a ratio first created at the beginning of an initial or first measuring period (e.g., a baseline monetary ratio). In one example, d can be the sum of relevant IT investments over a given period of time (e.g., multiple years, such as 7 years, etc.) divided by the number of DBAU at the end of this period of IT investment (which can be the beginning of the first measuring period). In such aspects, the value V of data can be represented by a formula such as V=d*DBAU, where DBAU, as explained above, can depend on one or more of the factors discussed herein. For example, using the example formula for DBAU provided above, V=d(A³ Σ₁ⁿΣ₁^{t}(U)), where V is value (in local currency, e.g., dollars, etc.), d is local currency per DBAU (e.g., as measured initially to determine a baseline, etc.), A is a percent accuracy for data in a given measurement period (e.g., as determined by audit, etc.), and U is the number of times an individual value was used over a period of time (e.g., an evaluation period, etc.). In various aspects, U, and consequently, terms that can be derived from U such as DBAU and V, can have varying degrees of granularity. For example, U can be based on a single database considered as a whole, individual elements in a database, or a mix of items with varying degrees of granularity.

By including the term d, to return a value V in a monetary unit (e.g., U.S. dollars, etc.), V can be compared to other investments on non-data items and can be more easily understood by executives. However, if d is tied to a historical or baseline value, although past expenditures are reflected in the value, current and future expenditures in data (e.g., IT, etc.) will not automatically increase the value V, but only if there are measured increases in the factors going into DBAU (in the example formula, these are A and U). In this way, effective expenditures can be distinguished from ineffective ones, encouraging executives to focus on behavior that produces positive results, instead of just throwing money at problems. The term A can reflect the decreased value of less accurate data. In various embodiments, such as the example above, the dependence of V on A can grow faster than linearly, for example, to reflect continued benefits in removing inaccuracies from sets of data that are already mostly (e.g., >90%, etc.) accurate, while still reflecting marginal increases of value of small improvements in accuracy. In other aspects, however, A³ can be replaced with a linear term. The U term can be included to reflect that assets that are not being used do not effectively confer value. For example, if $1M was spent on a system that was not ever used, then that $1M should be written off. In some embodiments, inclusion of this factor can obviate the need to include terms related to quantity of data or currency of data, although in some applications, inclusion of such terms can be included alongside U (e.g., in applications where data rapidly loses usefulness over time, but may still be used if it is the most current data over time, etc.). Use of programs or sets of data can be increased in various ways, some of which may be more effective in some organizations than in others. For example, teaching people to use a system can increase use, making the system more attractive can increase use. Additionally, adding a new system can increase use if the new system is adopted, while retiring an old system will decrease utility if the old system is still being used. Through the use of measures of value discussed herein, companies and other organizations can develop strategies that can maximize value while transitioning between systems, etc.

Additionally, systems and methods of the subject innovation can be partially implemented or implemented over time. For example, many organizations can make relatively accurate assessments of what are the 20% of their data stores that amount to 80% of their value, and can begin by valuing some of these.

In various aspects of the subject innovation, measures of value can be provided that can have relevance, ease of communication, and can be readily incorporated into a budget. In terms of relevance, the measures discussed herein can provide actual monetary (e.g., dollar, etc.) amounts associated with one or more values of data, which can be readily apprehensible by executives, and from which trends can be determined, and comparisons made to other types of assets or expenditures. By being able to provide this information at regular intervals and in an easily apprehensible format, these measures can facilitate communication and decisions involving data, IT, and associated expenditures. Additionally, in aspects, the measures discussed herein, and associated systems and methods, can be incorporated into existing companies and their budgets, and can provide for timely, objective, and consistent evaluations.

The subject innovation provides for one or more techniques to evaluate or measure a value associated with one or more data assets. These techniques can incorporate one or more qualities that can be selected to incentivize improving those qualities as they relate to the data assets. These qualities can include accuracy of data, extent to which data is used, size of data assets, currency or how recent data assets are, extent to which data assets are proprietary, and others. In specific embodiments, selection of qualities to be incorporated into a measure can vary, and can be based at least in part on whether inclusion of the quality or factor will incentivize beneficial behavior, actions, or decision-making based on such a measure. For example, in some applications, some of these qualities can be more important than in others, so that one or more specialized measures can be utilized, possibly in addition to a generalized measure, potentially even within the same organization. These measures can provide quantifiable values that companies can use to evaluate expenditures on data assets, as well as return on investment. Additionally, if a common measure is used to evaluate multiple departments or companies, comparisons can be made. These comparisons can be used to make additional decisions, for example to evaluate the value or effectiveness of data assets or IT departments, whether or not to implement strategies used in other companies or departments (e.g., by looking at whether the strategy resulted in a corresponding return on investment in improved accuracy, use of data assets, etc.), etc.

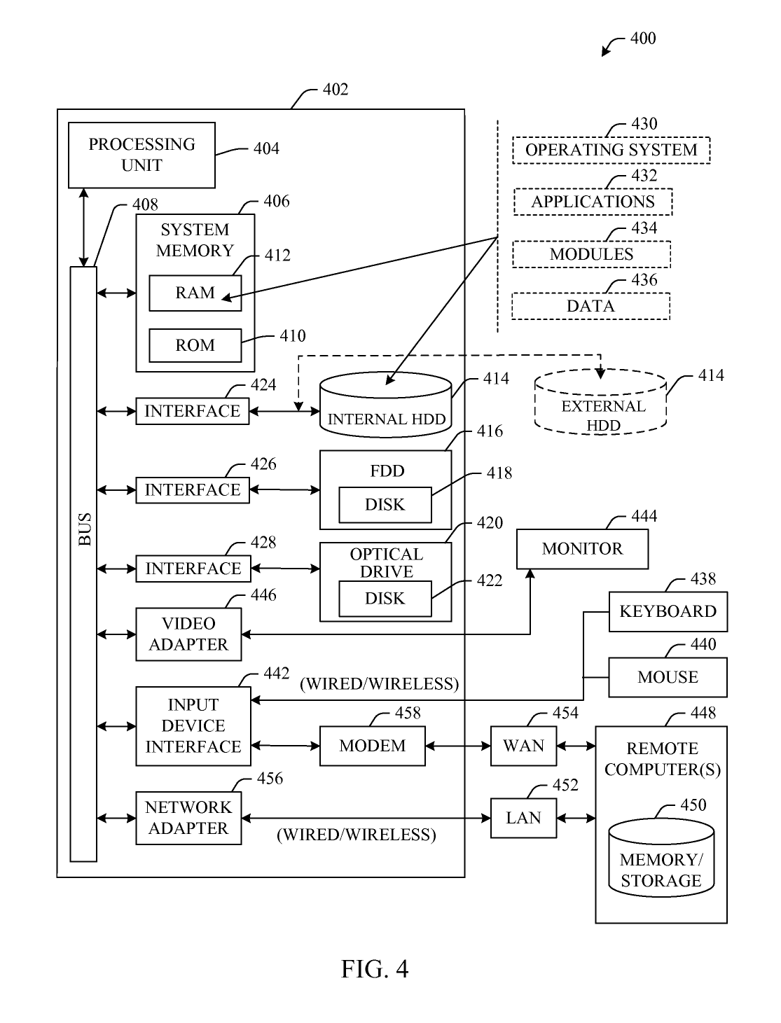

Referring now to FIG. 4, there is illustrated a block diagram of a computer operable to execute the disclosed architecture. In order to provide additional context for various aspects of the subject innovation, FIG. 4 and the following discussion are intended to provide a brief, general description of a suitable computing environment 400 in which the various aspects of the innovation can be implemented. While the innovation has been described above in the general context of computer-executable instructions that may run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 4, the exemplary environment 400 for implementing various aspects of the innovation includes a computer 402, the computer 402 including a processing unit 404, a system memory 406 and a system bus 408. The system bus 408 couples system components including, but not limited to, the system memory 406 to the processing unit 404. The processing unit 404 can be any of various commercially available processors. Dual microprocessors and other multi-processor architectures may also be employed as the processing unit 404.

The system bus 408 can be any of several types of bus structure that may further interconnect to a memory bus (with or without a memory controller), a peripheral bus, and a local bus using any of a variety of commercially available bus architectures. The system memory 406 includes read-only memory (ROM) 410 and random access memory (RAM) 412. A basic input/output system (BIOS) is stored in a non-volatile memory 410 such as ROM, EPROM, EEPROM, which BIOS contains the basic routines that help to transfer information between elements within the computer 402, such as during start-up. The RAM 412 can also include a high-speed RAM such as static RAM for caching data.

The computer 402 further includes an internal hard disk drive (HDD) 414 (e.g., EIDE, SATA), which internal hard disk drive 414 may also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high capacity optical media such as the DVD). The hard disk drive 414, magnetic disk drive 416 and optical disk drive 420 can be connected to the system bus 408 by a hard disk drive interface 424, a magnetic disk drive interface 426 and an optical drive interface 428, respectively. The interface 424 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 402, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the innovation.

A number of program modules can be stored in the drives and RAM 412, including an operating system 430, one or more application programs 432, other program modules 434 and program data 436. All or portions of the operating system, applications, modules, and/or data can also be cached in the RAM 412. It is appreciated that the innovation can be implemented with various commercially available operating systems or combinations of operating systems.

A user can enter commands and information into the computer 402 through one or more wired/wireless input devices, e.g., a keyboard 438 and a pointing device, such as a mouse 440. Other input devices (not shown) may include a microphone, an IR remote control, a joystick, a game pad, a stylus pen, touch screen, or the like. These and other input devices are often connected to the processing unit 404 through an input device interface 442 that is coupled to the system bus 408, but can be connected by other interfaces, such as a parallel port, an IEEE 1394 serial port, a game port, a USB port, an IR interface, etc.

A monitor 444 or other type of display device is also connected to the system bus 408 via an interface, such as a video adapter 446. In addition to the monitor 444, a computer typically includes other peripheral output devices (not shown), such as speakers, printers, etc.

The computer 402 may operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically includes many or all of the elements described relative to the computer 402, although, for purposes of brevity, only a memory/storage device 450 is illustrated. The logical connections depicted include wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which may connect to a global communications network, e.g., the Internet.

When used in a LAN networking environment, the computer 402 is connected to the local network 452 through a wired and/or wireless communication network interface or adapter 456. The adapter 456 may facilitate wired or wireless communication to the LAN 452, which may also include a wireless access point disposed thereon for communicating with the wireless adapter 456.

When used in a WAN networking environment, the computer 402 can include a modem 458, or is connected to a communications server on the WAN 454, or has other means for establishing communications over the WAN 454, such as by way of the Internet. The modem 458, which can be internal or external and a wired or wireless device, is connected to the system bus 408 via the serial port interface 442. In a networked environment, program modules depicted relative to the computer 402, or portions thereof, can be stored in the remote memory/storage device 450. It will be appreciated that the network connections shown are exemplary and other means of establishing a communications link between the computers can be used.

The computer 402 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11(a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

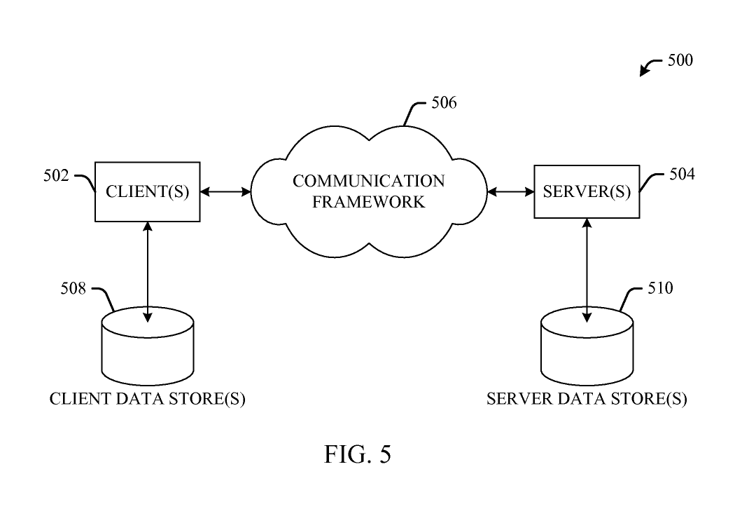

Referring now to FIG. 5, there is illustrated a schematic block diagram of an exemplary computing environment 500 in accordance with the subject innovation. The system 500 includes one or more client(s) 502. The client(s) 502 can be hardware and/or software (e.g., threads, processes, computing devices). The client(s) 502 can house cookie(s) and/or associated contextual information by employing the innovation, for example.

The system 500 also includes one or more server(s) 504. The server(s) 504 can also be hardware and/or software (e.g., threads, processes, computing devices). The servers 504 can house threads to perform transformations by employing the innovation, for example. One possible communication between a client 502 and a server 504 can be in the form of a data packet adapted to be transmitted between two or more computer processes. The data packet may include a cookie and/or associated contextual information, for example. The system 500 includes a communication framework 506 (e.g., a global communication network such as the Internet) that can be employed to facilitate communications between the client(s) 502 and the server(s) 504.

Communications can be facilitated via a wired (including optical fiber) and/or wireless technology. The client(s) 502 are operatively connected to one or more client data store(s) 508 that can be employed to store information local to the client(s) 502 (e.g., cookie(s) and/or associated contextual information). Similarly, the server(s) 504 are operatively connected to one or more server data store(s) 510 that can be employed to store information local to the servers 504.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates valuation of a data asset, comprising:
at least one processor coupled to a memory, the processor executes instructions associated with:
a data value management component that determines a measure of value of the data asset, wherein the measure of value is determined based at least in part on a baseline monetary ratio and a non-monetary measure of quality based on one or more factors; and
a communication component that outputs the measure of value.

2. The system of claim 1, wherein the baseline monetary ratio is based at least in part on an initial measure of value.

3. The system of claim 2, wherein the initial measure of value is based at least in part on one or more of a cost of gathering information associated with the data asset or information technology (IT) expenditures over a fixed period of time.

4. The system of claim 1, wherein the one or more factors comprise an accuracy of the data asset.

5. The system of claim 4, wherein the accuracy is determined based at least in part on an audit of at least a portion of the data asset.

6. The system of claim 5, wherein the data value management component comprises an audit component that determines the subset of the data asset.

7. The system of claim 1, wherein the one or more factors comprise a measure of use of the data asset.

8. The system of claim 7, wherein the measure of use is based at least in part on a number of accesses of the data asset during an evaluation period.

9. The system of claim 1, wherein the data value management component comprises a monitoring component that monitors the data asset to determine information associated with the one or more factors.

10. The system of claim 1, wherein the data value management component comprises a valuation component that compares the measure of value to at least one historical measure of value of the data asset.

11. The system of claim 1, wherein the data value management component comprises an analysis component that determines at least one trend based on at least one of the measure of value or the one or more factors.

12. A method that facilitates valuing a data asset, comprising:
employing at least one computer processor to execute the following:
determining an initial measure of value of the data asset;
calculating a baseline monetary ratio based at least in part on the initial measure of value;
measuring one or more quality factors associated with the data asset;
measuring a utility associated with the data asset;
calculating a new measure of value of the data asset based at least in part on the baseline monetary ratio, the utility, and the one or more quality factors; and
reporting the new measure of value.

13. The method of claim 11, wherein the initial measure of value is based at least in part on one or more of a cost of gathering information associated with the data asset or information technology (IT) expenditures over a fixed period of time.

14. The method of claim 11, wherein the one or more quality factors comprise an accuracy of the data asset.

15. The method of claim 14, further comprising:
determining a subset of the data asset to be audited;
auditing the subset of the data asset to measure an accuracy of the subset; and
setting the accuracy of the data asset equal to the accuracy of the subset.

16. The method of claim 11, wherein measuring the one or more quality factors comprises determining a number of accesses of the data asset during an evaluation period.

17. The method of claim 11, wherein reporting the new measure of value comprises reporting a comparison between the new measure of value and the initial measure of value.

18. The method of claim 11, wherein calculating the baseline monetary ratio comprises dividing the initial measure of value by an initial non-monetary measure of quality.

19. The method of claim 11, further comprising determining at least one trend based on at least one of the new measure of value or the one or more quality factors.

20. A system that facilitates valuation of a data asset, comprising:
at least one processor coupled to a memory, the processor executes instructions associated with:
a data value management component that determines a new measure of value of the data asset, wherein the new measure of value is the product of a baseline monetary ratio and a new non-monetary measure of quality based on an accuracy and a measure of use of the data asset, and wherein the baseline monetary ratio is equal to an initial measure of value divided by an initial non-monetary measure of quality; and
a communication component that outputs the measure of value.
